(19) United States
(12) Patent Application Publication
(10) Pub. No.: US 2012/0225398 A1
(43) Pub. Date: Sep. 6, 2012

(54) Orthodontic Archwire And Bracket System

(76) Inventor: Ashin Al Fallah, San Diego, CA (US)

(21) Appl. No.: 13/365,474

(22) Filed: Feb. 3, 2012

Related U.S. Application Data
(60) Provisional application No. 61/439,338, filed on Feb. 3, 2011.

(51) Int. Cl. A61C 7/12

(52) U.S. Cl. 433/8

(57) ABSTRACT

The invention is an archmatrix. In one embodiment the archmatrix of the invention comprises: an occlusal wire; an apical wire; and a plurality of connecting elements located between the occlusal wire and the apical wire (see, e.g., FIG. 3). The connecting elements serve to connect and maintain the configuration of the occlusal and apical wires. The connecting elements can take the form of interconnecting network or mesh. A complementary set of brackets are used to attach the archmatrix to a patient's teeth. The archmatrix can comprise archwires in addition to the occlusal and apical wires.

### CROSS-REFERENCE TO RELATED APPLICATIONS

This application claims the benefit of priority from U.S. Provisional Patent Application Ser. No. 61/439,338 (filed Feb. 3, 2011). The entire content of Provisional Patent Application Ser. No. 61/439,338 is incorporated herein by reference in its entirety.

### STATEMENT REGARDING FEDERALLY SPONSORED RESEARCH OR DEVELOPMENT

Not Applicable.

### FIELD OF THE INVENTION

This invention relates to orthodontic devices. More specifically the invention is directed to an archmatrix in combination with a bracket system to aid in the correction of malposed teeth or to maintain existing teeth positions.

### BACKGROUND OF THE INVENTION

U.S. Pat. No. 7,828,549 issued to Wildman describes a self-ligating orthodontic bracket system, comprising a bracket to be mounted on the lingual side of the tooth and a self-ligating insert. The insert comprises a retention arm and a lockarm pivotally engaged together. The retention arm includes: a retention spring; a topside arm; and a pivot ring connecting the retention spring to the topside arm. The lockarm includes: an attachment portion having a pivot bar configured to be received in the pivot ring of the retention arm; a strut portion connected to the attachment portion; and a clasp portion having a clasp lock and an unlocking opening. The clasp lock is configured to engage a chokebox stem of the bracket. A retention groove in the bracket retains the retention arm of the insert. The bracket includes slots for occlusal, edgewise and gingival archwires.

As noted by Wildman in U.S. Pat. No. 7,828,549, orthodontic treatment of the teeth is generally accomplished by applying force to the teeth with a series of archwires positioned in and across a number of brackets. Since the beginning of orthodontics, in the late 1800's, orthodontists have been pursuing the goals of increased appliance resiliency, control, comfort to the patient, and easier manipulation for the doctor.

U.S. Pat. No. 3,775,850 discloses an orthodontic apparatus employing parallel unbent arch wires in cooperation with brackets having predetermined ideal three dimensional positions built into the bracket structure for each tooth. Friction between the bracket and arch wires is minimized by using point contacts. In one embodiment, a plastic bracket may be used having snap-in slots for holding the arch wires. In another embodiment a staple may be inserted in the bracket to hold the arch wires. Both embodiments also permit the use of ligature wires to hold the arches. The unbent light arch wires may be configured in pairs, normally one above the other, or in threes, triangular or in line, to provide greater rigidity. Substantial time saving is achieved through the use of the orthodontic apparatus herein disclosed while at the same time achieving greater success with less skill by the practitioner. The invention overcomes the shortcomings of prior art “edgewise” and “light-wire” orthodontic techniques.

U.S. Pat. No. 7,014,460 discloses an orthodontic appliance such as a bracket or buccal tube has a latch for retaining an archwire in an archwire slot. The latch releases the archwire from the archwire slot whenever the archwire exerts a force on the appliance that exceeds a certain minimum value. The latch comprises at least one clip having certain features that significantly reduce strain during opening movements of the clip, so that the likelihood of fracture of the clip during use is significantly reduced.

U.S. Pat. No. 7,033,170 describes an orthodontic bracket assembly has a bracket having base with a mounting portion for attachment to a patient's tooth, and a plurality of arms forming a bracket slot to receive a rectangular archwire. A clip can be removeably inserted into the bracket slot along the axis of the bracket slot and archwire, and is retained by the bracket slot. The assembled bracket slot and clip form a rectangular channel to removeably secure the archwire in the bracket slot. Two of the archwire surfaces are engaged by the clip and the remaining two archwire surfaces are engaged by walls of the bracket slot.

U.S. Pat. No. 7,025,591 discloses a self-ligating orthodontic appliance including a base, one or more pivotally and movably mounted jaws on the base, and a spring member actuable to coact with the base and jaws and selectively move the jaws between open and closed positions.

U.S. Pat. No. 6,939,133 describes an orthodontic bracket, which in one embodiment is a pre-engaging orthodontic bracket that includes a body having a lingual surface for attachment to a tooth, a pair of laterally spaced gingival tie wings and a pair of laterally spaced occlusal tie wings. The gingival and occlusal tie wings project from a labial surface of the body. An archwire slot extends mesiodistally across the body and between the gingival and occlusal tie wings at opposed mesial and distal sides of the body to accommodate an archwire. A pivot pin extends between a pair of the tie wings at opposed mesial and distal sides of the body. A shutter is moveable relative to the body between an open position in which placement and removal of an archwire into the archwire slot is facilitated and a closed position in which placement and removal of an archwire into the archwire slot is inhibited.

U.S. Pat. No. 6,913,459 discloses an orthodontic bracket having a plastic bracket, a base which is directly or indirectly secured to the teeth, a bracket main body, an archwire slot for receiving an archwire, and a liner. The orthodontic bracket is furnished with flared portions at outsides of the liner.

U.S. Pat. No. 7,214,057 discloses an orthodontic bracket assembly and method of assembling an orthodontic bracket assembly. The bracket assembly may generally include a base defining an archwire slot and having a lingual surface attachable to a tooth, the base defining a recess extending from the lingual surface, an insert positionable in the recess, a slot being at least partially defined by the insert, and a locking member including a lingual portion receivable in the slot to support the locking member on the base, the lingual portion being movable in the slot between an open position, in which the locking member permits access to the archwire slot, and a closed position, in which the locking member inhibits access to the archwire slot.

U.S. Pat. No. 7,204,690 discloses an orthodontic bracket or convertible buccal tube for use with arch wires has the usual mesial distal extending slot having one side open to receive the wire. The open side is closed by a shutter pivoting on a pivot pin, or coaxial pins, about a mesial distal axis, the shutter being latched in slot closed position to retain the arch wire in the slot. The device includes an attitude controlling spring member consisting of an integral extension of the part of the shutter member that closes the slot, the extension being thinner and therefore of greater flexibility than the relatively rigid shutter member. The extension can be progressively thinner that the shutter member from its junction therewith to a free end that engages the archwire in the slot. In slot closed position a portion of the integral extension is positively engaged with a surface of the device body so as to preload the spring. Also in slot closed position the integral extension is engaged by lateral walls of the device body parallel to an occlusal, gingival, labial, lingual plane to protect it against mesial or distal directed stresses applied thereto.

U.S. Pat. No. 7,837,466 discloses an orthodontic device includes a bracket having a body and the body includes external surfaces. An archwire passageway is formed in the body. An aperture extends from one of the external surfaces of the body to the passageway. A pawl is attached to the body and includes stop and cam surfaces which extend into the aperture. An extendable archwire includes an adjustment portion having a locking surface and a loop-spring therein and the adjustment portion is inserted into and through the passageway. The pawl and the locking surface form a ratchet. The cam surface of the pawl interengages the extendable archwire as the extendable archwire is extended through the bracket under the application of force to the extendable archwire. The stop surface of the pawl inter-engages the locking surface of the adjustment portion of the extendable archwire preventing retraction of the extendable archwire upon discontinuation of the application of force.

### SUMMARY

The following summary presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

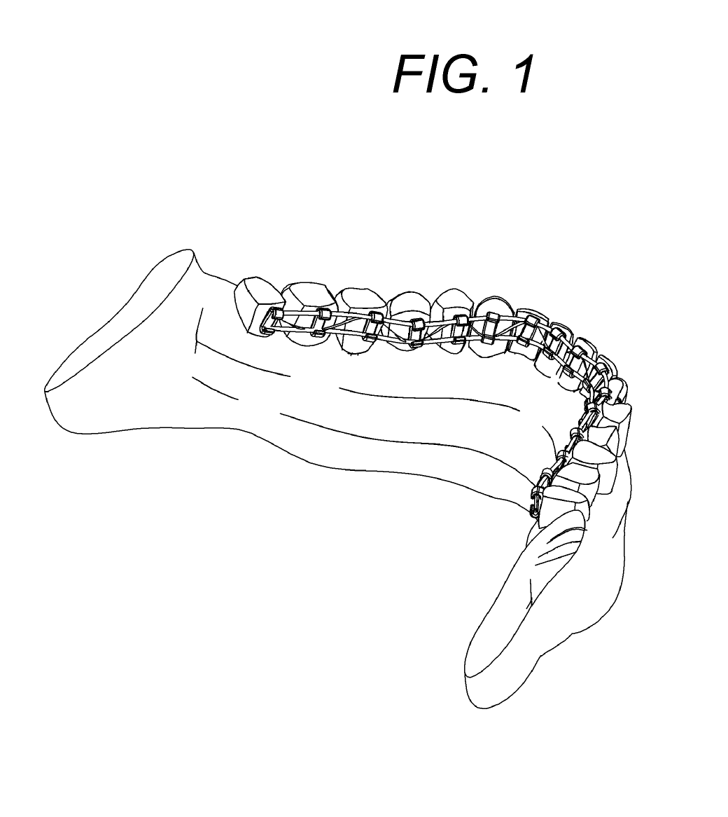

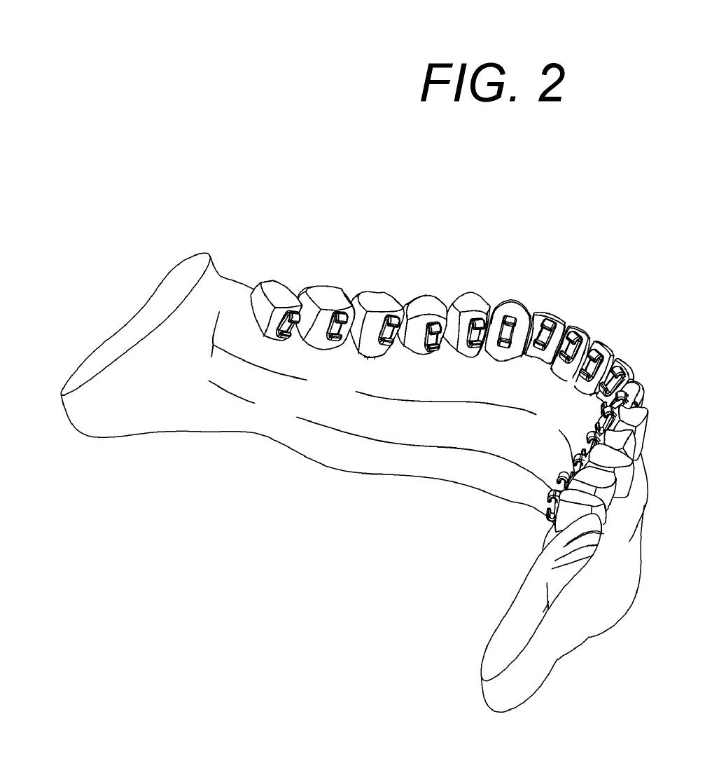

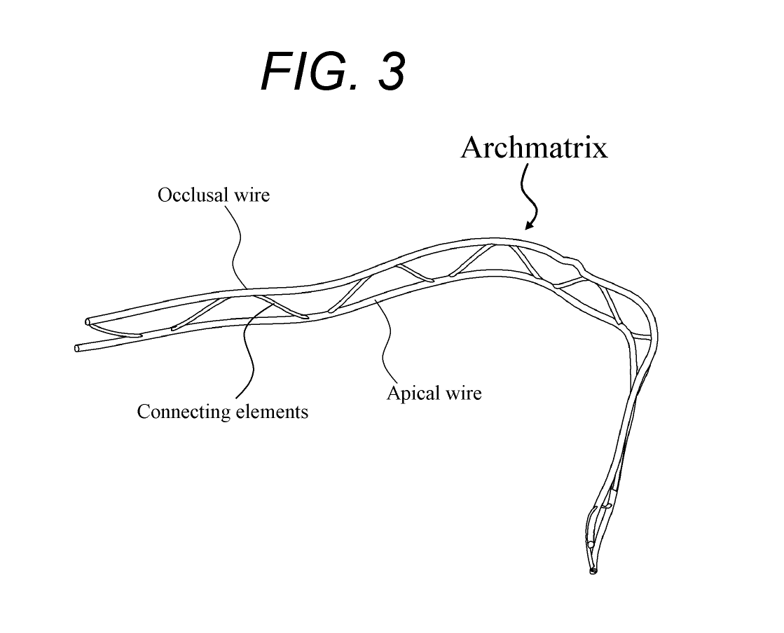

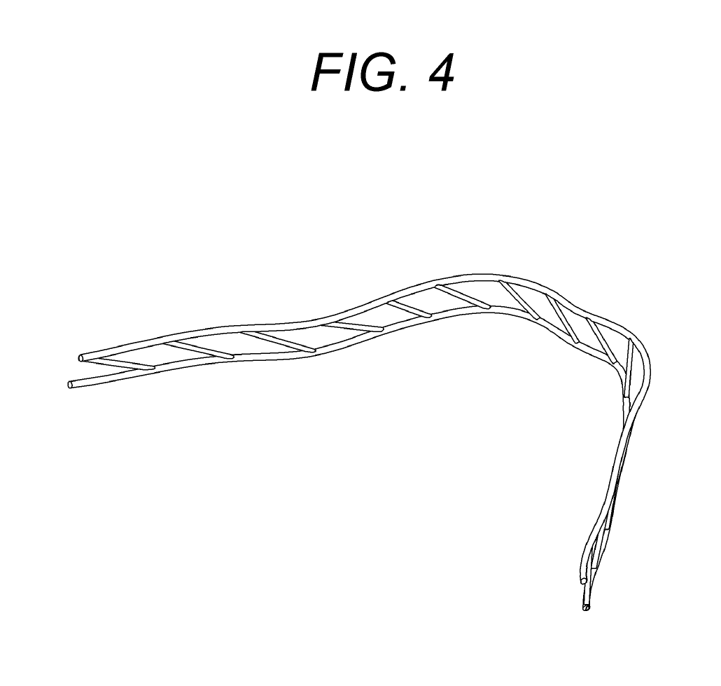

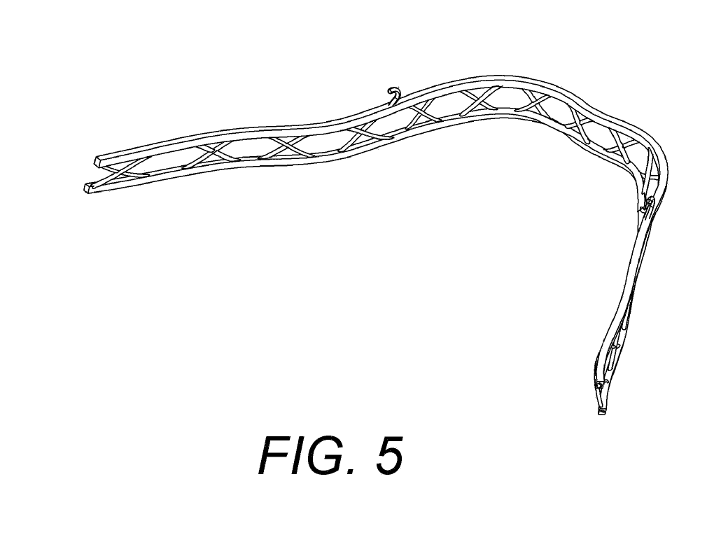

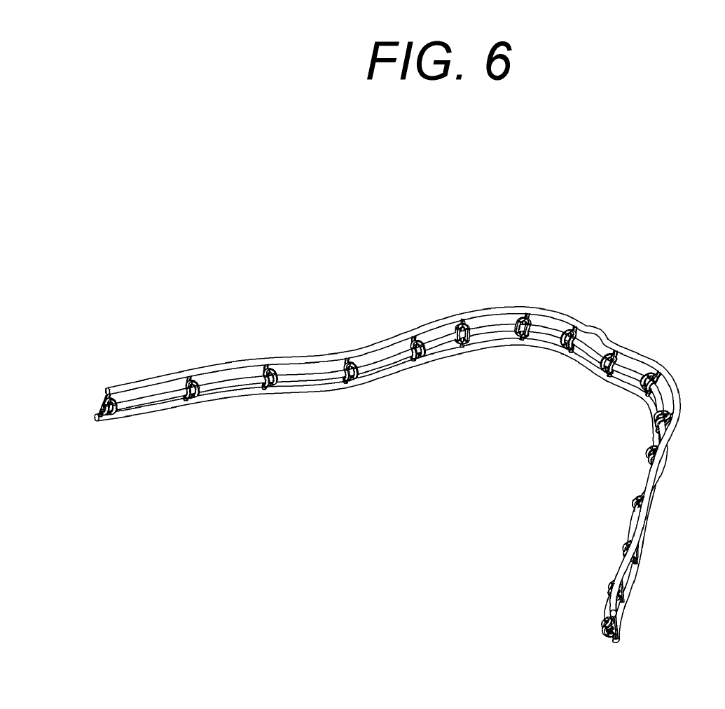

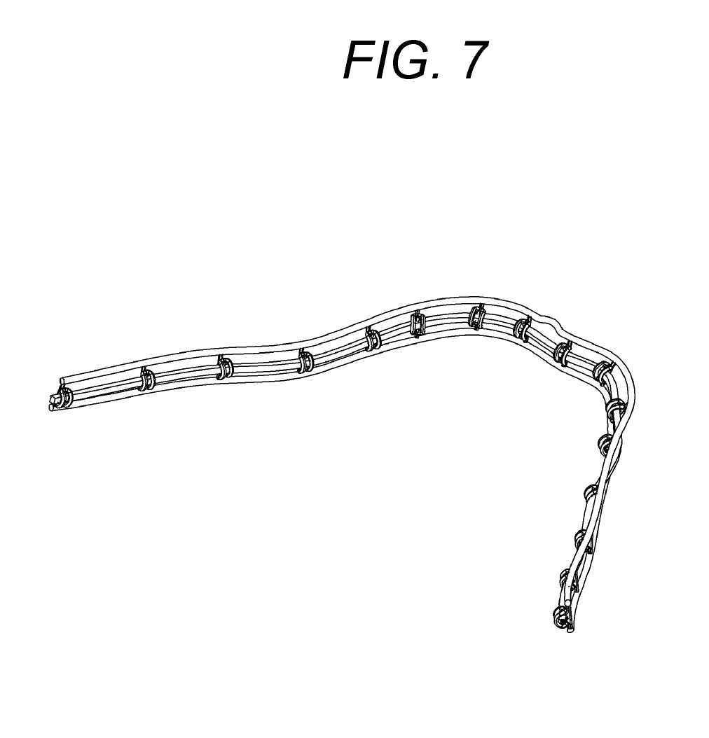

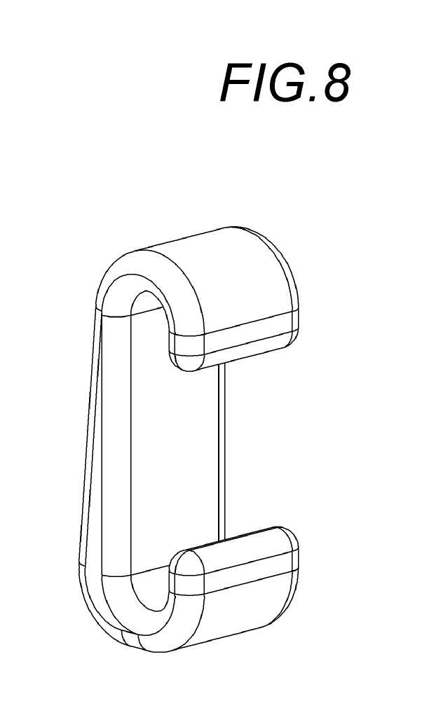

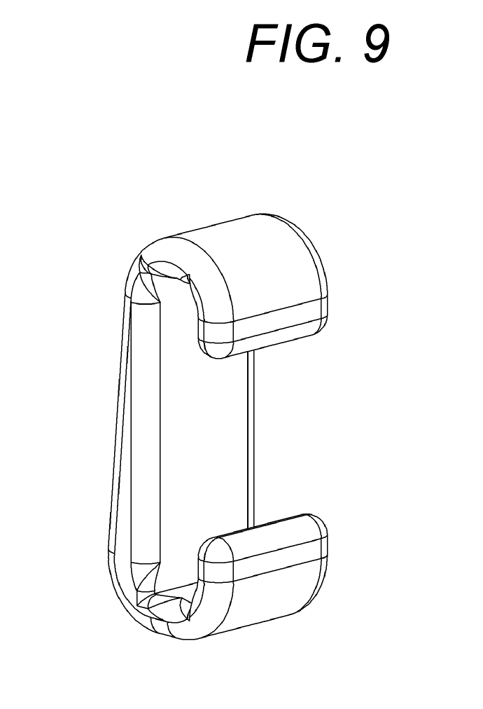

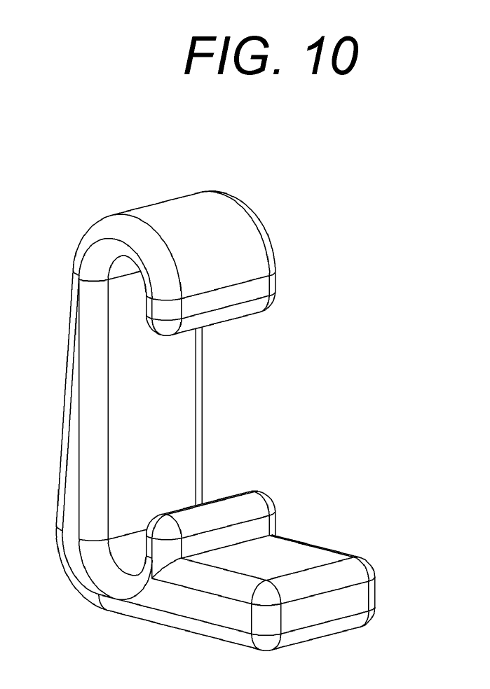

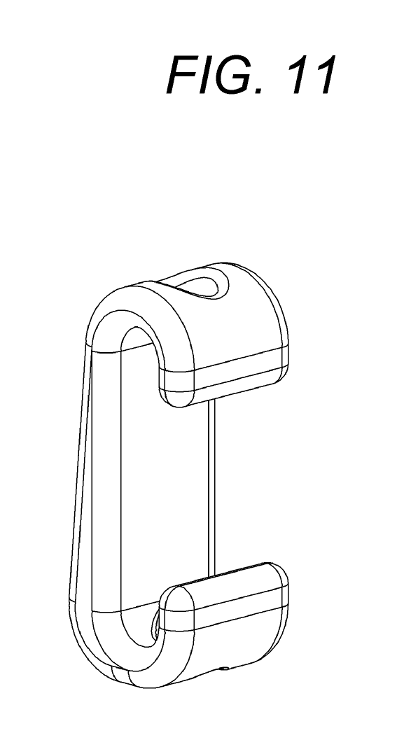

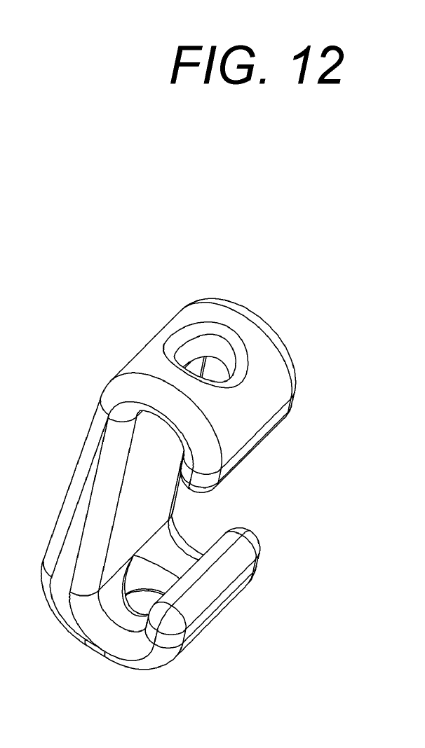

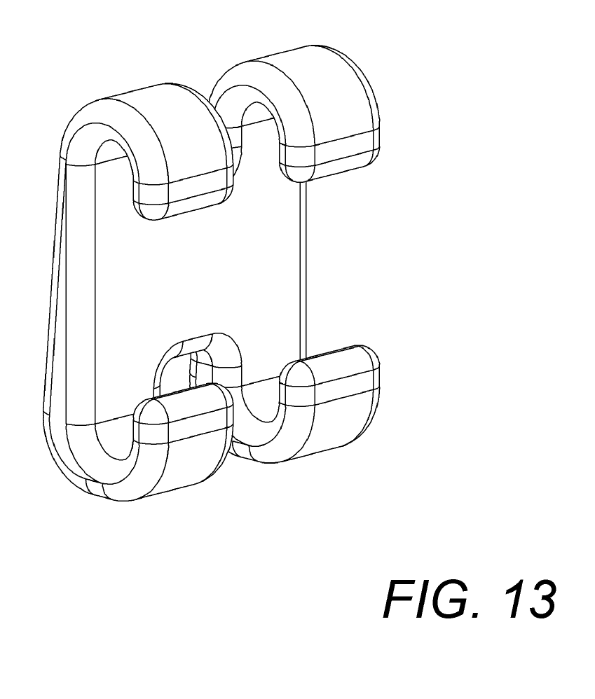

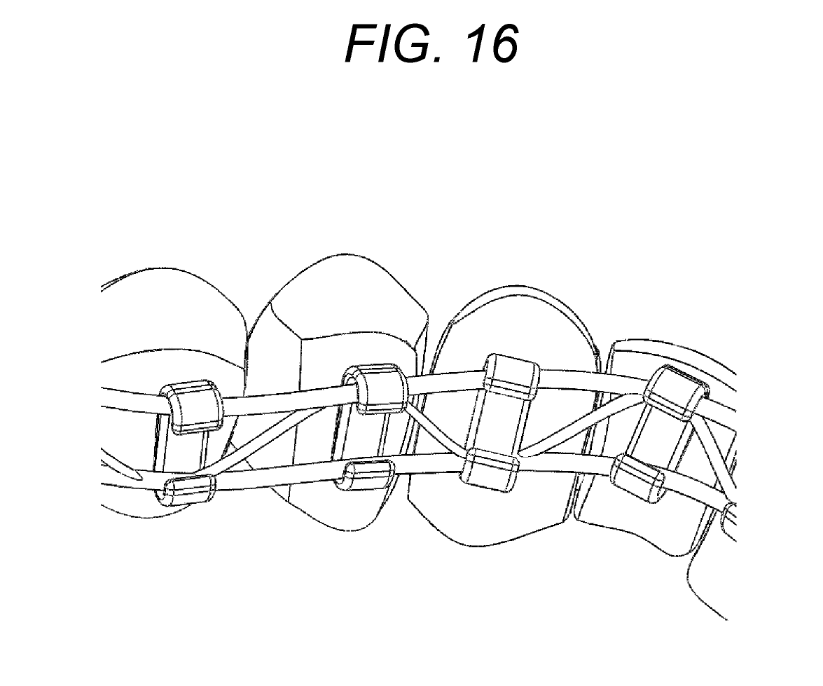

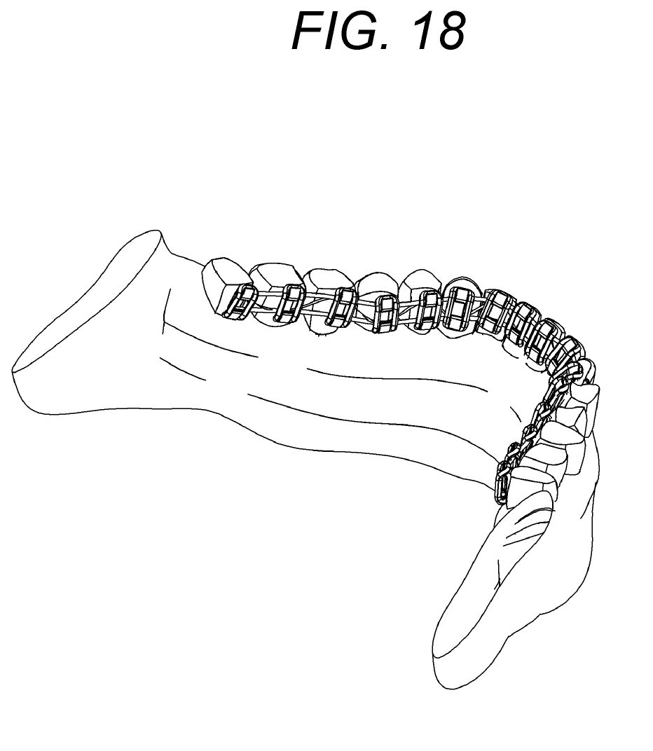

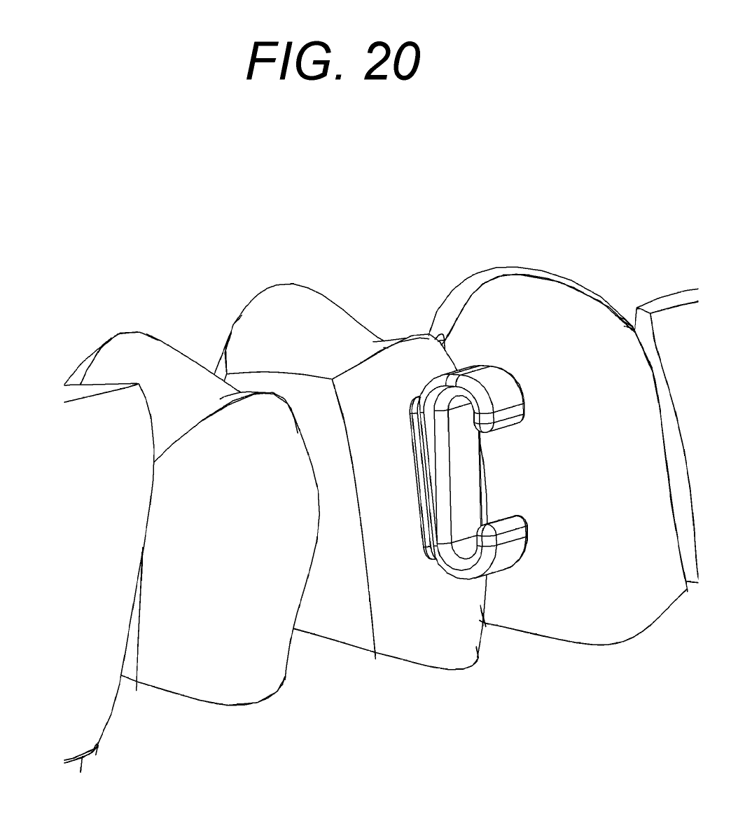

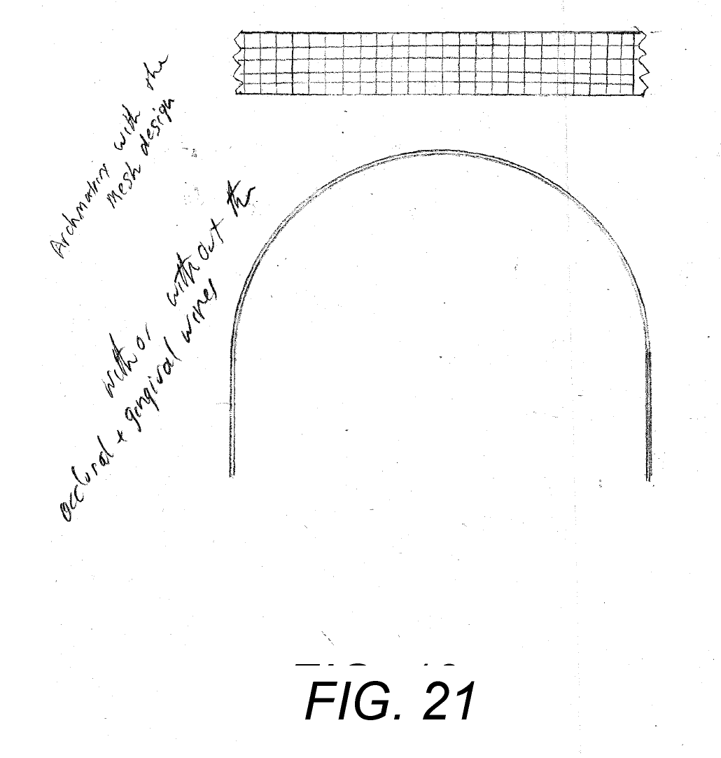

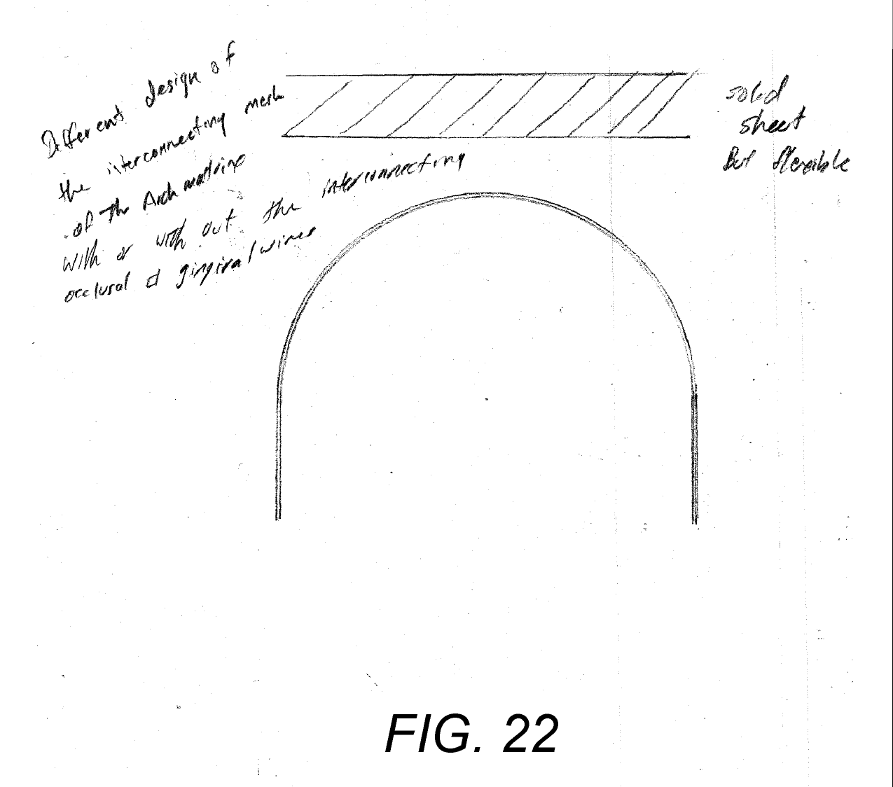

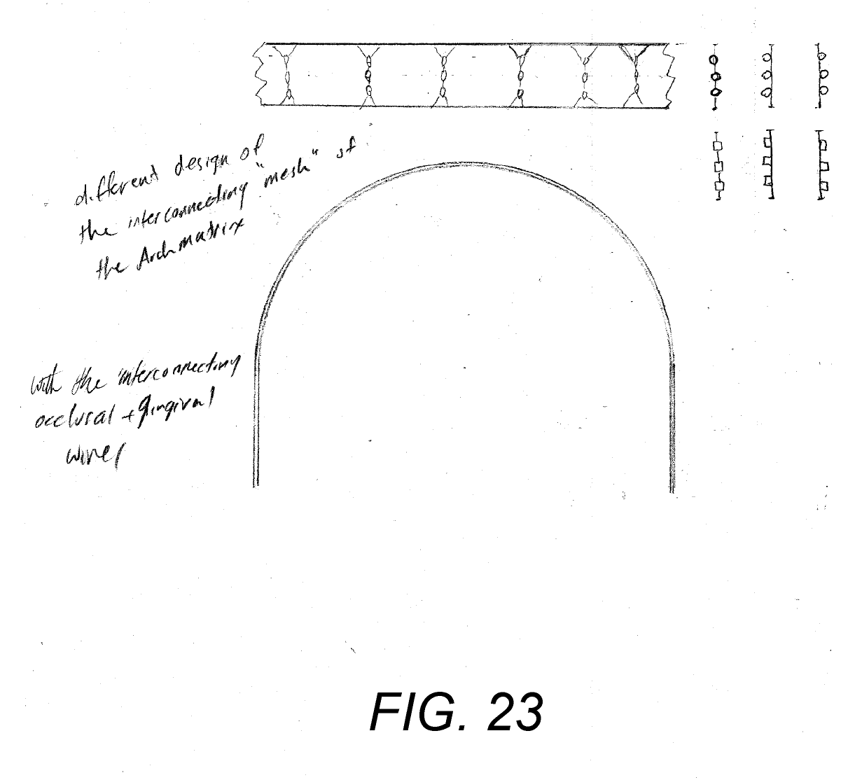

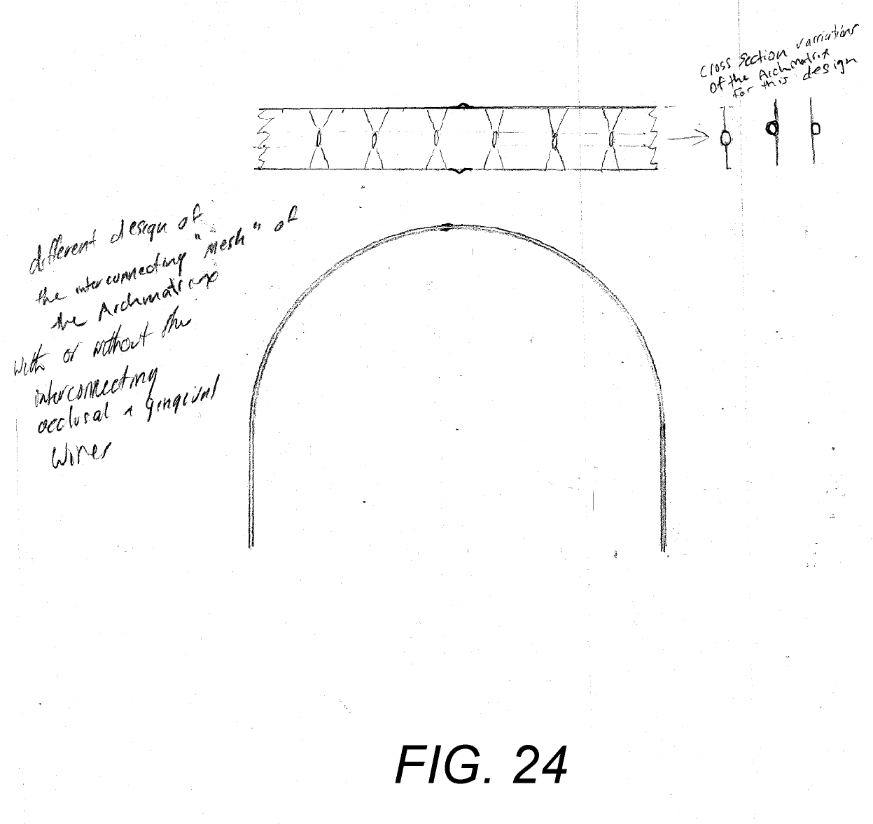

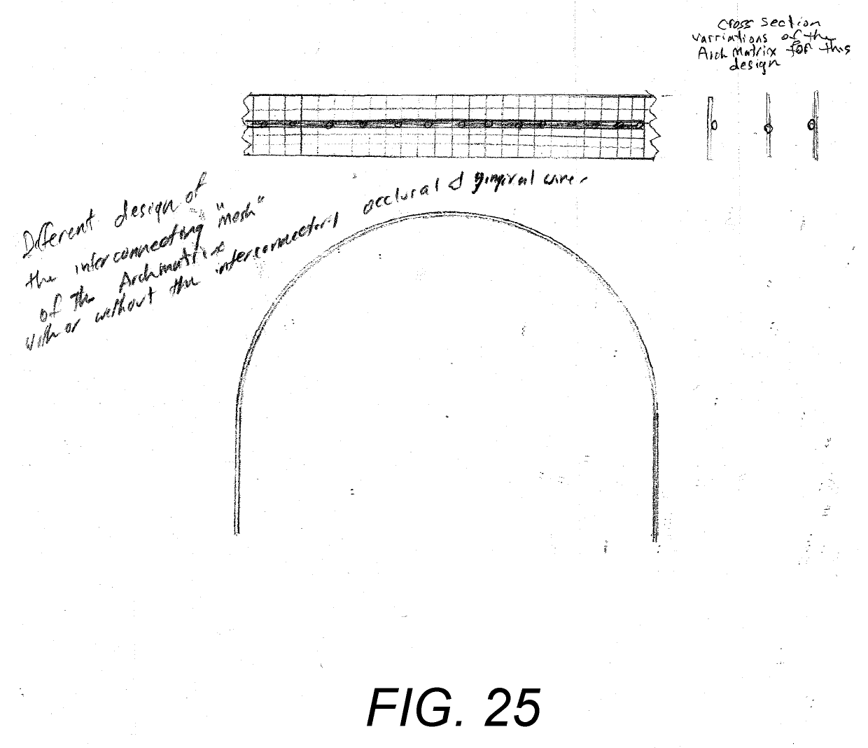

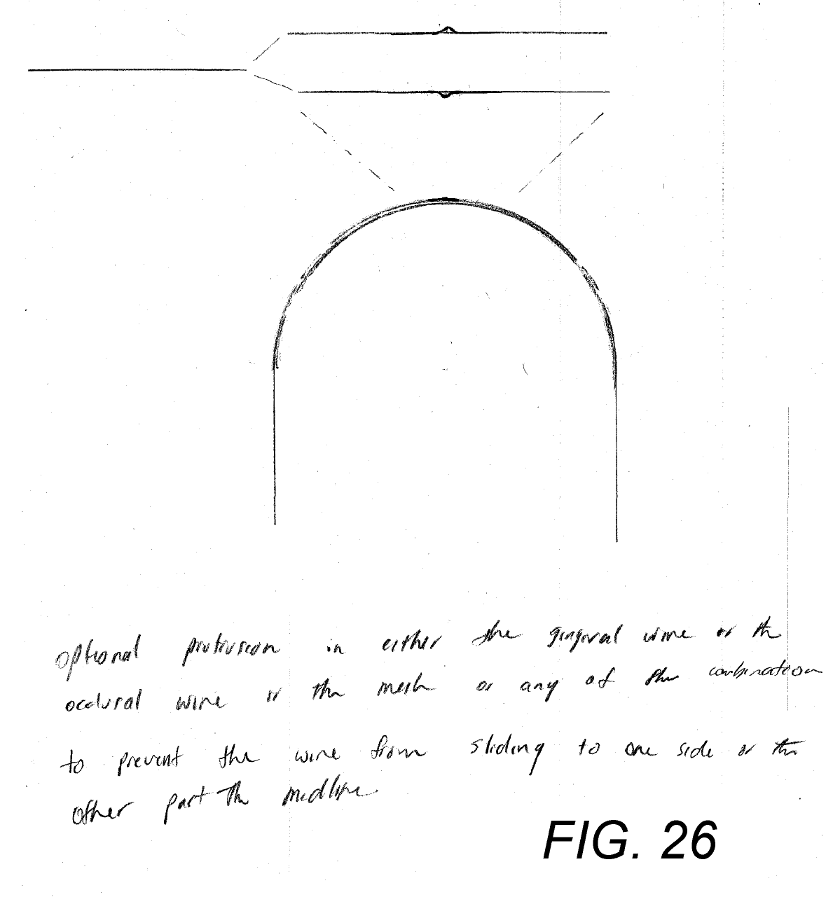

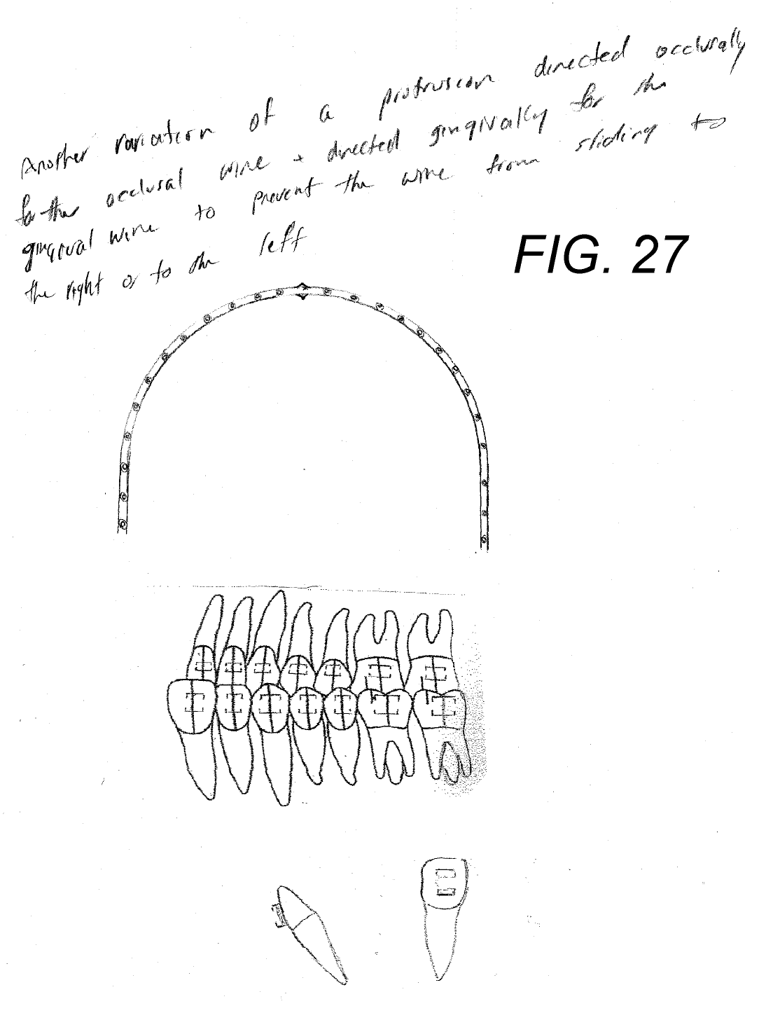

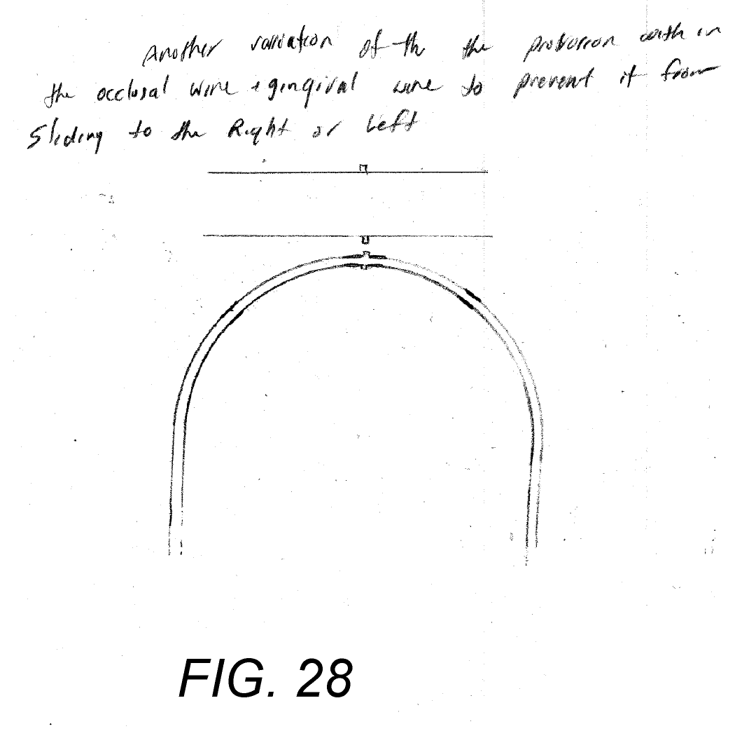

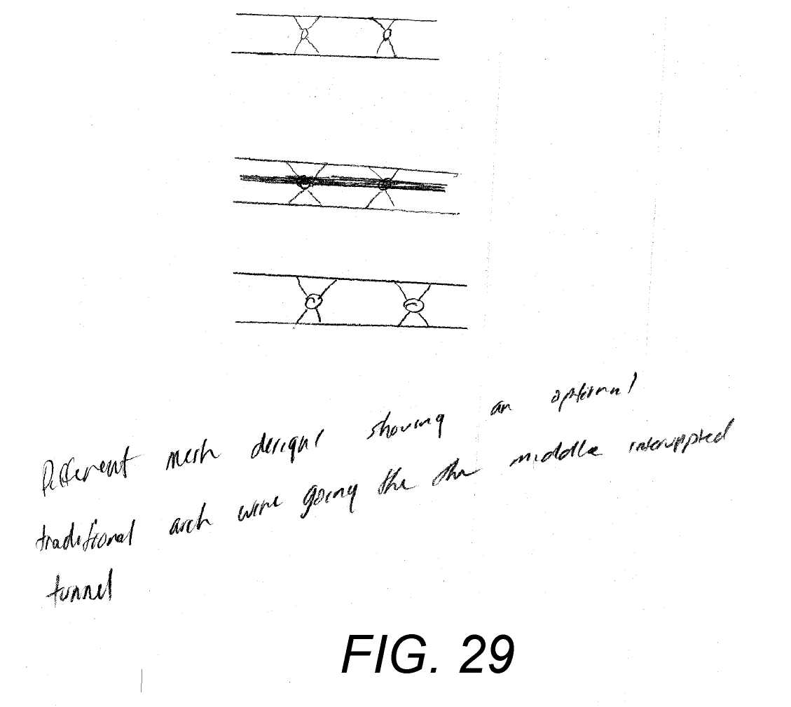

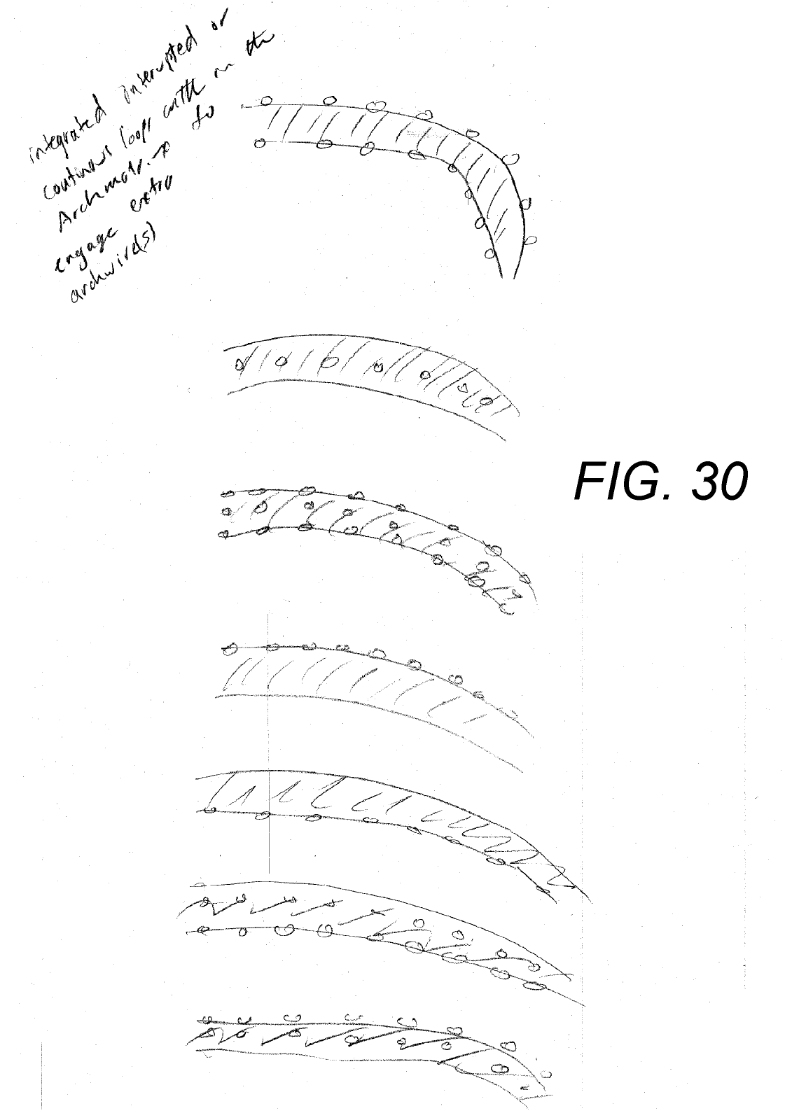

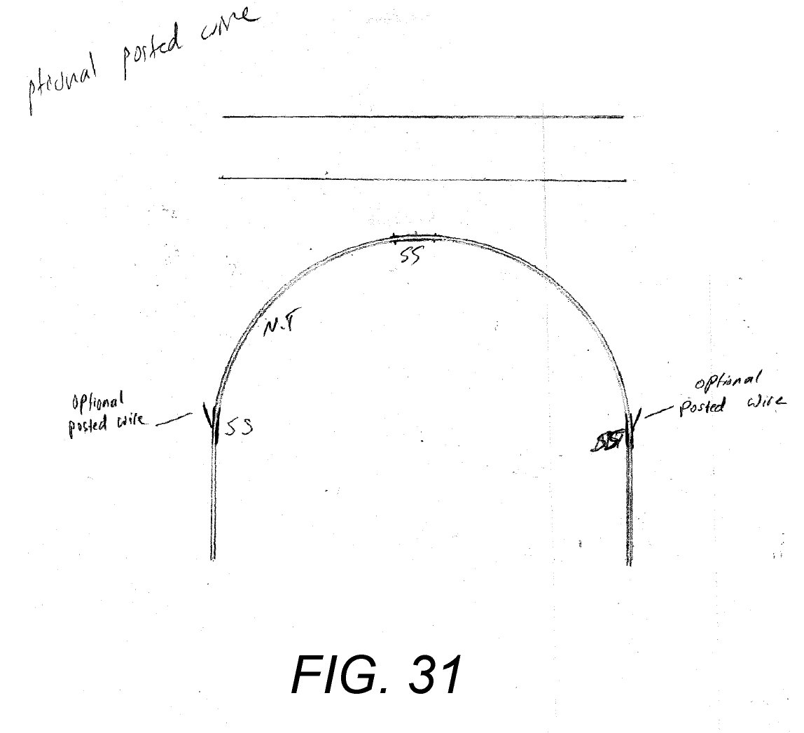

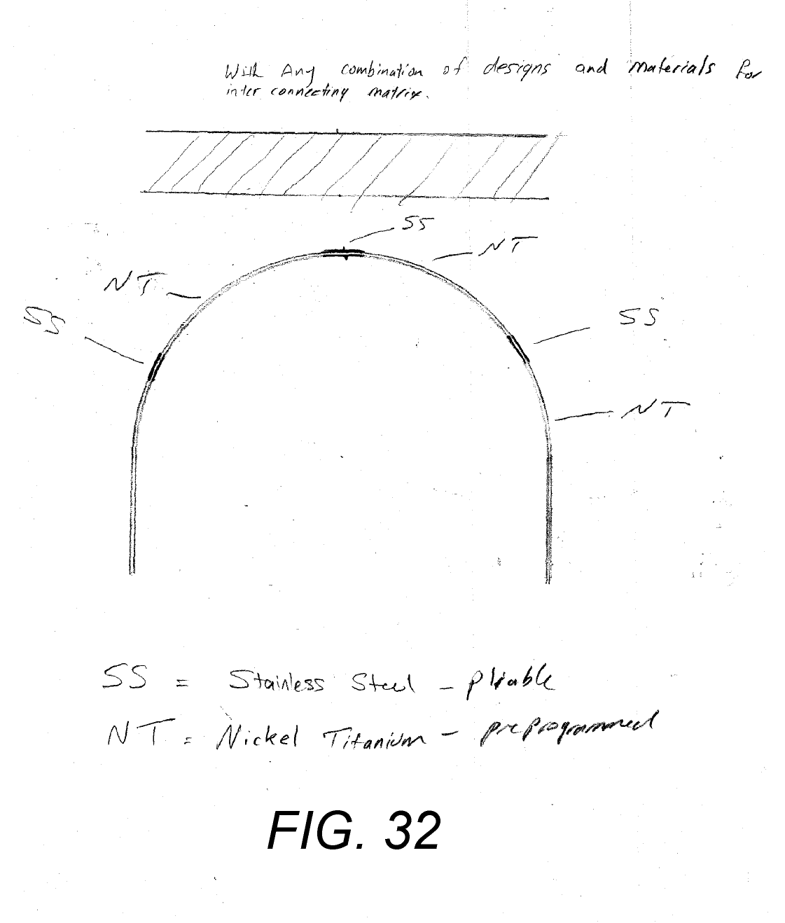

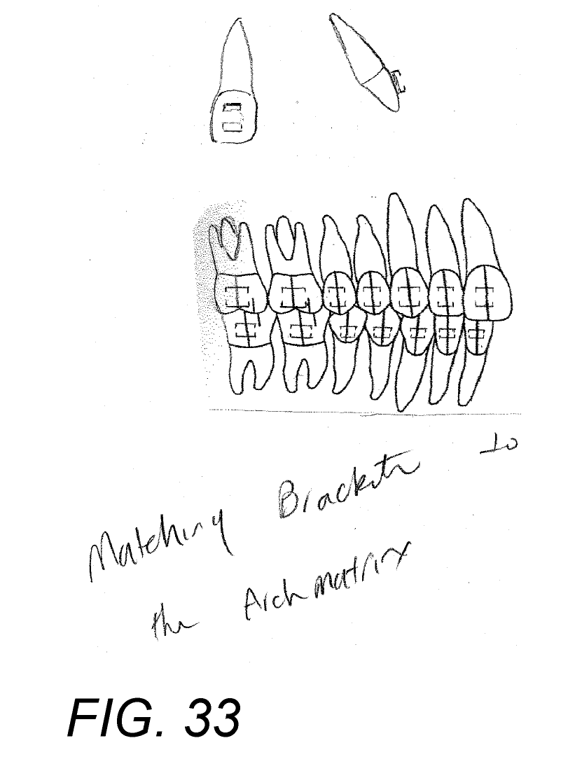

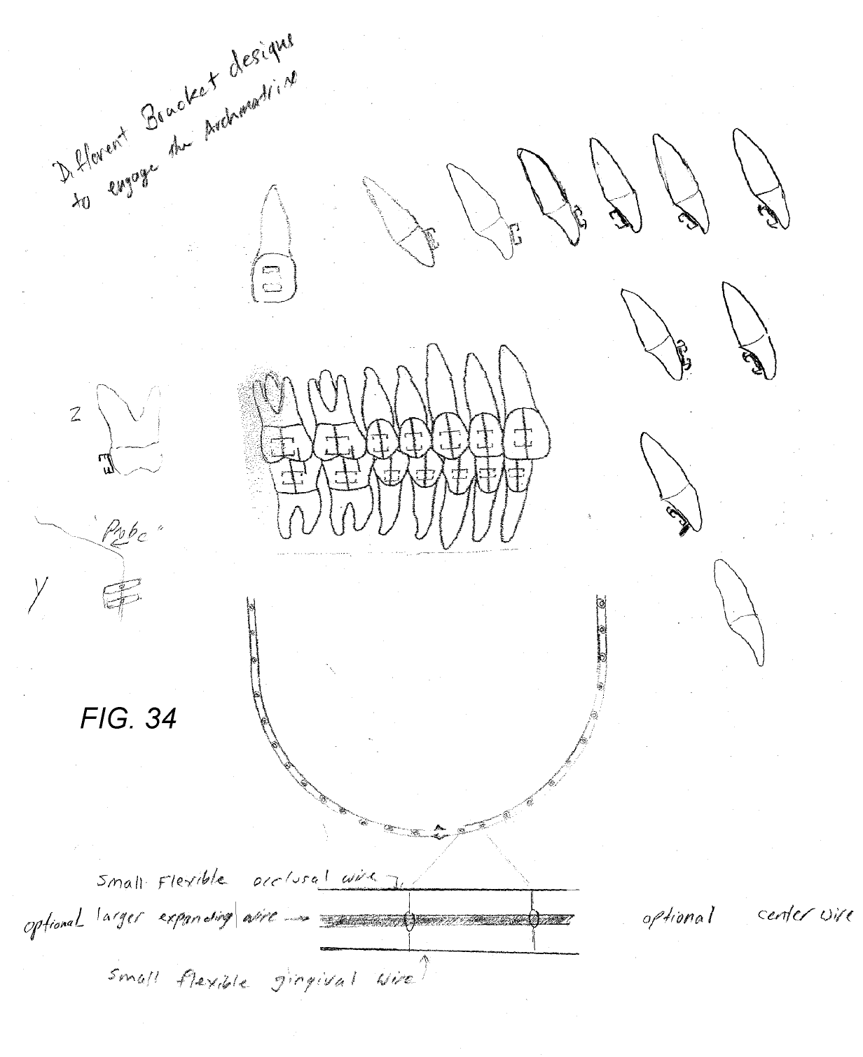

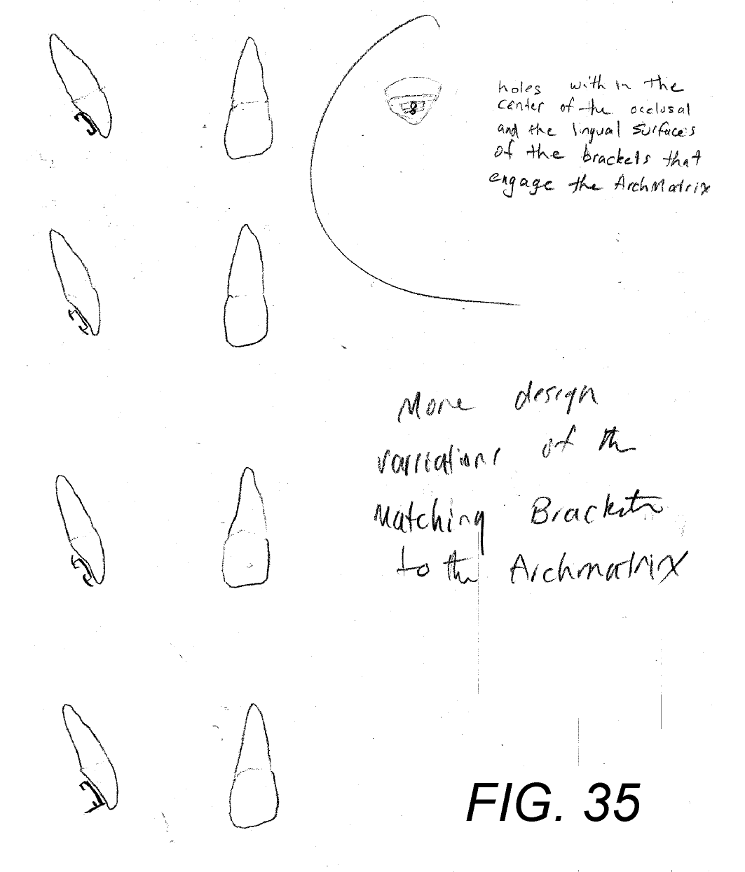

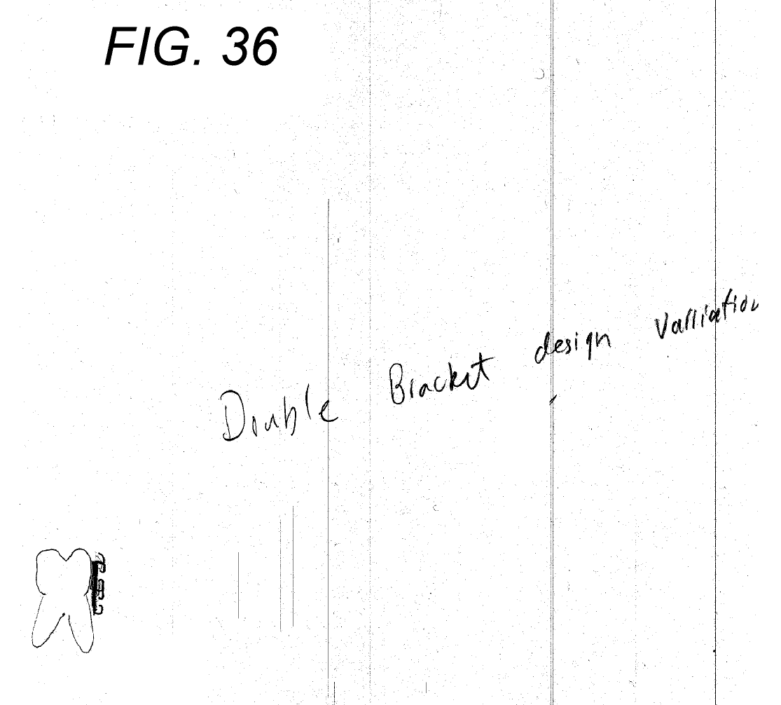

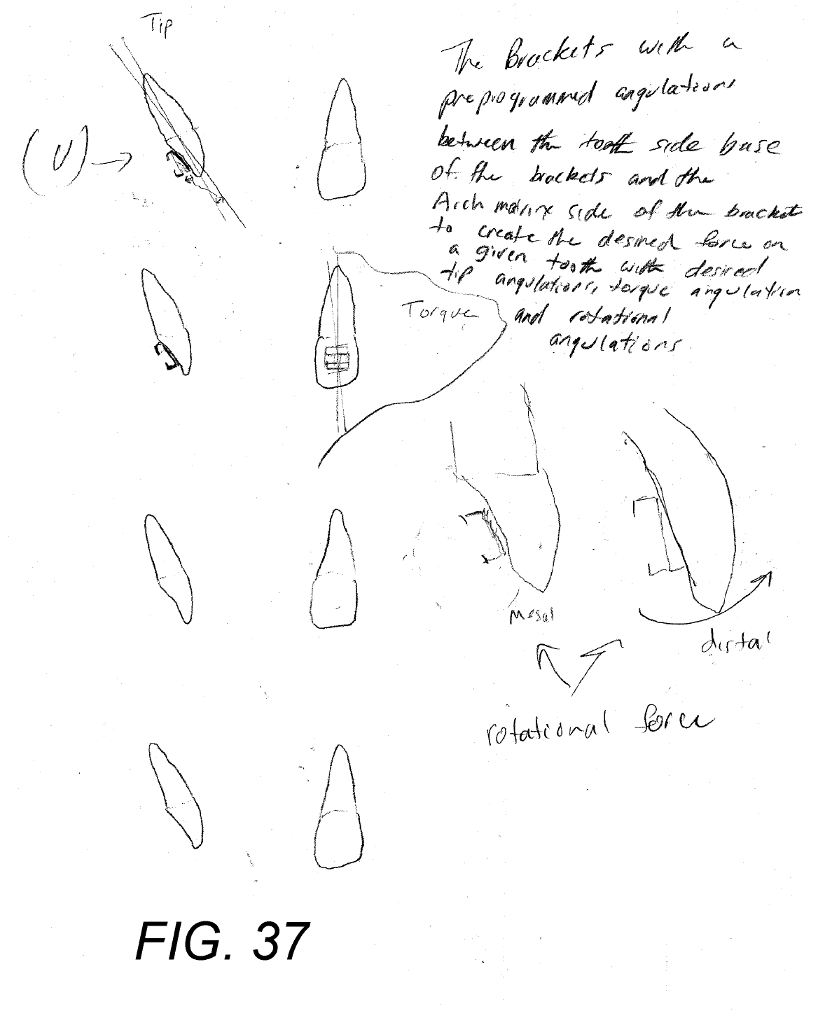

The present invention provides an archmatrix. In one embodiment the archmatrix of the invention comprises: an occlusal wire; an apical wire; and a plurality of connecting elements located between the occlusal wire and the apical wire (see, e.g., FIG. 3). The connecting elements serve to connect and maintain the configuration of the occlusal and apical wires. The connecting elements can take the form of interconnecting wires (e.g., see FIGS. 3 through 5) or mesh (see, e.g., FIG. 21). A complementary set of brackets are used to attach the archmatrix to a patient's teeth (see, e.g. close up views of exemplar brackets in FIGS. 8-20). The archmatrix can comprise archwires in addition to the occlusal and apical wires (see, e.g., FIG. 6).

### BRIEF DESCRIPTION OF THE DRAWINGS

The attached Figures show various aspects of the present invention.

### DETAILED DESCRIPTION OF THE PREFERRED EMBODIMENTS OF THE INVENTION

This invention is directed to orthodontic devices. More specifically the invention is directed to an archmatrix in combination with a bracket system to aid in the correction of malposed teeth or to maintain existing teeth positions. Appendix A attached hereto forms part of the detailed description of the invention.

The invention is an archmatrix. In one embodiment the archmatrix of the invention comprises: an occlusal wire; an apical wire; and a plurality of connecting elements located between the occlusal wire and the apical wire (see, e.g., FIG. 3). The connecting elements serve to connect and maintain the configuration of the occlusal and apical wires. The connecting elements can take the form of interconnecting wires (e.g., see FIGS. 3 through 5) or mesh (see, e.g., FIG. 21). A complementary set of brackets are used to attach the archmatrix to a patient's teeth (see, e.g., FIGS. 8-20). It should be understood that while the attached Figures shows brackets attached to the lingual surfaces of a patient's teeth, the inventive device can be fitted to the facial surfaces of a patient's teeth.

The occlusal and apical wires respectively have first and second gauges. The gauges of the occlusal and apical wires can be the same or can be different. The occlusal and apical wires can be made of any suitable material such as stainless steel which can be bent to a predetermined shape. The occlusal and apical wires are preferably made from nickel titanium which retains its pre-programmed memory. More specifically, the occlusal and apical wires are made of first and second materials wherein the first and second materials can be the same or different materials. The archmatrix can comprise archwires in addition to the occlusal and apical wires (see, e.g., FIG. 6). The terms “apical” and “gingival” are regarded as equivalent terms.

Segments of the occlusal and apical wires can be made of pre-programmed shape with a material such as nickel titanium and segments with pliable material such as stainless steel. For example, the segment of the occlusal and apical wires that corresponding to the central incisor teeth and the segment corresponding to the canines can be made in pliable stainless steel, and the rest of the occlusal and apical wires made with a pre-programmed material such as nickel titanium. This combination will provide the gentle, more forgiving and comfortable properties of a pre-programmed material such as nickel titanium with the segments in a pliable material such as stainless steel which provide the capacity to ply the Archmatrix to the desired arch size. The pliable segments will hold the change that the practitioner introduces to the Archmatrix, while the preprogrammed segments will provide a gentler way of transmitting the force to the teeth via the matching brackets.

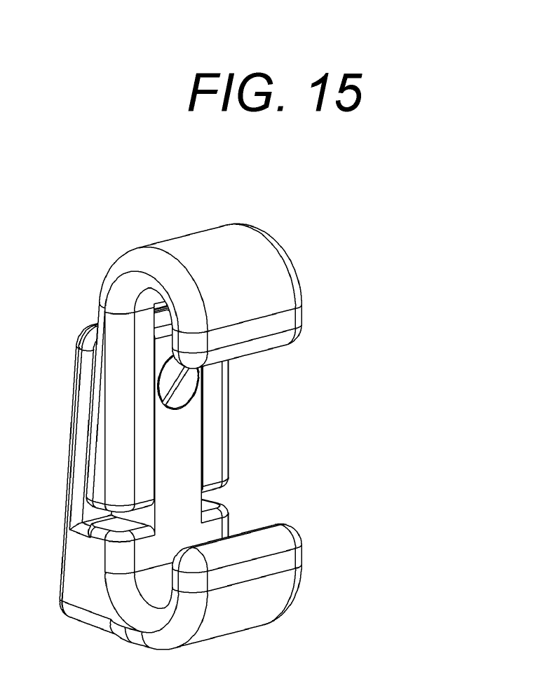

The archmatrix can also be made of a single solid sheet of, for example, nickel titanium. To this end a bracket is provided to accommodate a single solid sheet. For example, FIG. 15 shows an embodiment where the apical or the occlusal components of the brackets are adjustable. This allows the two components to slide away from each other to accommodate a more rigid form of the archmatrix. Once the archmatrix is placed in position, the two apical and occlusal components of the brackets are brought closer to each other and then the sliding part is locked.

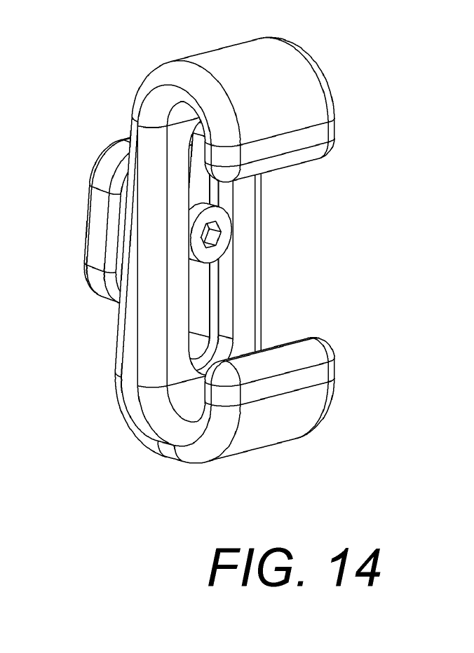

FIG. 14 shows an adjustable bracket system. The position of the bracket can be adjusted to accommodate any necessary mid treatment correction. This is a lot easier and less time consuming than taking the bracket off and re-cementing it.

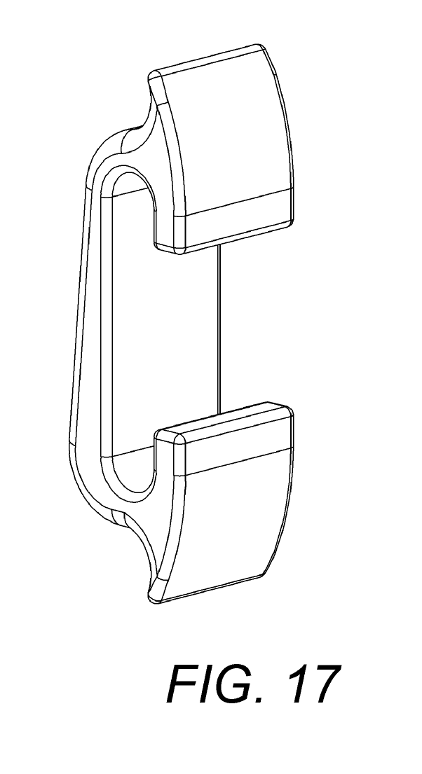

FIG. 17 shows a different design of the bracket system that allows the use of the elastomeric O-ring to secure the archmatrix further. This might be necessary in case of severe misalignment or to minimize the wire from sliding in a mesio-distal direction.

The archmatrix has an occlusal side and an apical side, which can be squeezed together to place through the slot of a bracket (examples of brackets are show in FIGS. 8-20), and when the two sides are not being squeezed, the two sides will spring away from each other and hence, self engage the archmatrix into the corresponding brackets. This is because the material and the design of the Archmatrix are such that the area between the occlusal boundary and the apical boundary is made so that it flexes and then rebounds to its pre-programmed shape. In other words, the interconnecting matrix is made of a material that gives it flexibility, yet, it wants to bounce back a pre-programmed shape, especially in the occlusal-apical plane.

The Archmatrix is typically made of a occlusal wire with a circular or regular polygonal cross-section such as, but not limited to, square or rectangular or hexagonal cross-section or an irregular polygonal cross-section; and similarly the apical wire can have a circular or regular polygonal cross-section such as, but not limited to, square or rectangular or hexagonal cross-section or an irregular polygonal cross-section and are connected to each other by a plurality of connecting elements such as, but not limited to, thin interconnecting wires or mesh. The mesh can take any suitable form such as a regular square or diamond mesh or an irregular mesh with irregularly spaced wires. The mesh can be made out of any suitable materials such as, but not limited to, nickel titanium or out of polymer such as a plastic polymer. The mesh needs to be flexible. So when the dental practitioner squeezes the wires towards each other, the mesh will flex. After the practitioner stops squeezing the wires towards each other, the mesh should rebound to its original shape and dimensions.

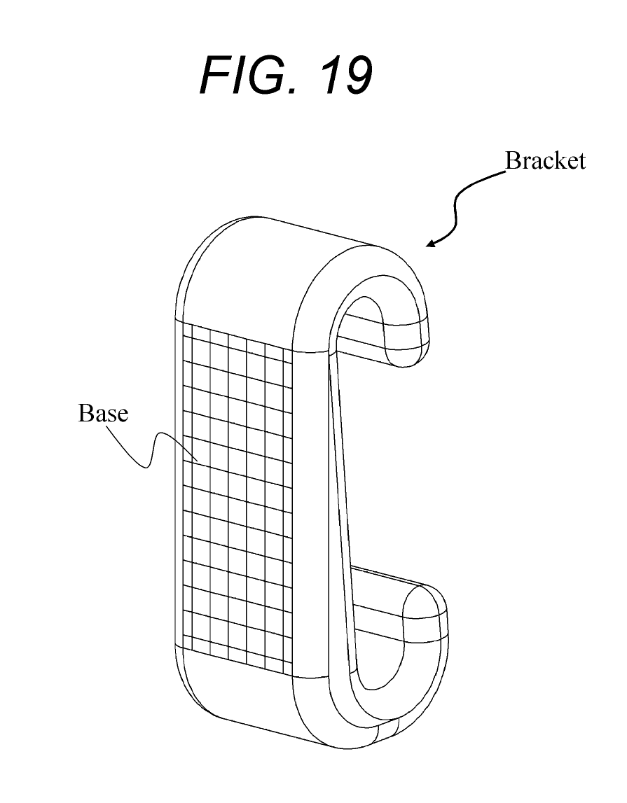

In one possible design the two (or more strands) are connected via a very thin, flexible Nickel Titanium mesh that maintains its pre designed shape within the normal temperature ranges that a typical person's mouth is exposed to (32° F.-180° F.). The outer two archwires can be squeezed towards each other with fingers, to fit into brackets cemented or otherwise attached to a dental patient's teeth; the brackets can be attached to the buccal or lingual surface of a patient's teeth. More specifically, the brackets of the invention each typically have a base (see, e.g., FIG. 19) that is attached to the lingual or buccal facial surface of a patient tooth; typically the base is cemented to the lingual or buccal facial surface of a tooth. More specifically, each bracket is attached to the lingual or buccal facial surface of its corresponding tooth (each tooth has its matching base), and the other side engages the archwire matrix (referred to in this paper as an “archmatrix”). The dentist or the orthodontist or the assistant can either manually (with two fingers) can easily and quickly place or remove the archmatrix from the matching bracket system with out the need for ligature ties or any existing self ligating mechanisms.

The novelty of this invention arises in part because the archwire matrix (archmatrix) is self securing without the need of elastic ties, ligature ties or self ligating gate system. The archmatrix has a minimum of two wires, one typically engages the occlusal aspect of each bracket and the second wire engages the gingival aspect of each bracket. The minimum of the two wires and the interconnecting mesh creates a dynamic 3 dimensional force vector. To move the roots of the teeth (especially the molars) with the conventional single stranded orthodontic archwires requires larger diameter rectangular wires with an immediate force delivery on the bracket and the tooth (even with the nickel titanium wires that are gentler than the stainless steel wires). Due to the flexibility of a mesh, and the presence of a minimum of two archwires, the apical wire can have either a synergistic effect as the occlusal wire or an opposite vector relative to the occlusal wire. For example, if the proposed archmatrix and the brackets are placed on the lingual of the teeth, and both wires have a buccal vector of expansion with a slightly stronger expansion vector with the apical wire, then the proposed teeth will expand buccally with the roots expanding slightly more than the crowns of the teeth. This will create an expansion without flaring of the crowns of the teeth. Conversely, the dynamics of the apical versus the occlusal wires can be customized for each patient or can be mass produced in different vector combinations for different existing and desired arch sizes (for example, but not limited to the desired arch sizes based on Schwatz arch size analysis).

In one embodiment, there can be low force, small, flexible apical and occlusal wires with interconnecting dynamic mesh with a stronger, more rigid wire going through the center of the mesh. The advantage of this embodiment is that smaller diameter apical and occlusal wires will do the leveling and aligning of the teeth, with the larger central wire exerting more of expansion force for the arch. Also, the other advantage is that the larger wire's excess torque will be distributed into the more flexible mesh, the smaller flexible apical and the occlusal wire. This will allow the stronger force of the larger wire to be gradually transferred to the teeth in the course of a few months. With this system the therapeutic force is buffered via the flexible mesh and smaller apical and occlusal wires, instead of the over stressing the periodontal ligaments and the adjoining bone structure. The necessary force to move a tooth is between 34 grams and 150 grams. More than 150 gram results in ankylosis, root resorption and damage to the teeth. The built in buffer system of the present invention provides gentle force delivery over a much longer time span will also reduce the number of wire changes and speeds up the orthodontic treatment and minimizes discomfort and root resorption.

What is claimed:

1. An orthodontic archwire and bracket system, comprising:
an orthodontic archwire comprising:
an occlusal wire,
an apical wire, wherein the occlusion wire and apical wire include lengths of nickel titanium and lengths of stainless steel, and
a plurality of connecting elements located between the occlusal wire and the apical wire; and
a set of brackets for connecting the orthodontic archwire to a user's teeth.
